(19) United States
(12) Patent Application Publication
(10) Pub. No.: US 2020/0357552 A1
(43) Pub. Date: Nov. 12, 2020

(54) CURRENT CONTROLLER AND HYDRAULIC SYSTEM

(71) Applicant: DENSO CORPORATION, Kariya-city (JP)

(72) Inventors: Fuminori SUZUKI, Kariya-city (JP); Yuta MIZUNO, Kariya-city (JP)

(21) Appl. No.: 16/941,875

(22) Filed: Jul. 29, 2020

Related U.S. Application Data
(63) Continuation of application No. PCT/JP2019/001145, filed on Jan. 16, 2019.

(30) Foreign Application Priority Data
Jan. 31, 2018 (JP) 2018-015448

(51) Int. Cl. H01F 7/06; H01F 7/08; F16K 31/06; G05D 16/20

(52) U.S. Cl. CPC H01F 7/064; G05D 16/2024; F16K 31/0613; H01F 7/081

(57) ABSTRACT

A current controller for controlling a current of a solenoid is applied to a solenoid valve with a self-regulating pressure function from a feedback force according to an output hydraulic pressure. The current controller includes a current detector configured to detect an actual current of the solenoid, a drive unit configured to energize the solenoid with a predetermined energization period according to a drive signal, a signal output unit that sets a duty ratio of the drive signal such that the actual current follows a target current, the signal output unit being configured to generate and output the drive signal, a target setting unit that applies a dither amplitude with a dither period longer than the energization period, and an oscillation determination unit that determines, based on a behavior of the actual current, whether excessive oscillation is occurring or is trending toward excessive oscillation.

### CROSS REFERENCE TO RELATED APPLICATIONS

The present application is a continuation application of International Patent Application No. PCT/JP2019/001145 filed on Jan. 16, 2019, which designated the U.S. and claims the benefit of priority from Japanese Patent Application No. 2018-15448 filed on Jan. 31, 2018, the disclosure of both of which is incorporated herein by reference.

### TECHNICAL FIELD

The present disclosure relates to a current controller.

### BACKGROUND

A solenoid valve typically includes a solenoid which operates a valve element. A current controller may be provided to control the solenoid of the solenoid valve by regulating the amount of current applied to the solenoid.

### SUMMARY

According to the present disclosure, a current controller for controlling a current of a solenoid is applied to a solenoid valve with a self-regulating pressure function from a feedback force according to an output hydraulic pressure.

The current controller includes a current detector configured to detect an actual current of the solenoid, a drive unit configured to energize the solenoid with a predetermined energization period according to a drive signal, a signal output unit that sets a duty ratio of the drive signal such that the actual current follows a target current, the signal output unit being configured to generate and output the drive signal, a target setting unit that applies a dither amplitude to the target current such that the target current changes periodically with a dither period longer than the energization period, and an oscillation determination unit that determines, based on a behavior of the actual current, whether excessive oscillation is occurring or is trending toward excessive oscillation as compared to minor oscillations caused by applying the dither amplitude to the target current.

### BRIEF DESCRIPTION OF DRAWINGS

The above and other objects, features and advantages of the present disclosure will become more apparent from the following detailed description made with reference to the accompanying drawings. In the drawings:

FIG. 1 is a schematic diagram showing an automatic transmission to which a current controller is applied.

FIG. 2 is a cross sectional view of a solenoid valve.

FIG. 3 is a characteristic diagram showing the relationship between the strokes of the solenoid valve spool and the output hydraulic pressure.

FIG. 4 is an enlarged view of a main part of the solenoid valve, showing a state where the stroke is in a first hydraulic pressure gentle curve region of FIG. 3.

FIG. 5 is a cross sectional view taken along line V-V of FIG. 4.

FIG. 6 is an enlarged view of a main part of the solenoid valve, showing a state where the stroke is in a hydraulic pressure steep curve region of FIG. 3.

FIG. 7 is a cross sectional view taken along line VII-VII of FIG. 6.

FIG. 8 is an enlarged view of a main part of the solenoid valve, showing a state where the stroke is in a second hydraulic pressure gentle curve region of FIG. 3.

FIG. 9 is a cross sectional view taken along line IX-IX of FIG. 8.

FIG. 10 is a block diagram illustrating functional units of a current controller.

FIG. 11 is a time chart diagram showing current and target current when the current controller executes a current control process.

FIG. 12 is a diagram showing a relationship between stroke slope and an actual current change amount when the duty ratio change amount is within a predetermined range during a stable period.

FIG. 13 is a diagram showing a relationship between stroke slope and an actual current change amount when the duty ratio change amount is within a predetermined range during an excessive oscillation transition period.

FIG. 14 is a diagram showing a relationship between stroke slope and an actual current change amount when the duty ratio change amount is within a predetermined range during an excessive oscillation occurrence period.

FIG. 15 is a time chart diagram showing duty ratio, actual current, stroke, and stroke slope during a current control process in a stable period.

FIG. 16 is a time chart diagram illustrating a process executed by a current controller.

FIG. 17 is a time chart diagram showing current and target current when the current controller detects excessive oscillation.

FIG. 18 is a time chart diagram showing a force balanced state of the spool when the current controller executes current control.

FIG. 19 is a flowchart illustrating a process executed by the current controller.

FIG. 20 is a block diagram illustrating functional units of the current controller.

FIG. 21 is a flowchart illustrating a process executed by the current controller of FIG. 20.

FIG. 22 is a block diagram illustrating functional units of the current controller.

FIG. 23 is a time chart diagram showing current and target current when the current controller of FIG. 22 detects excessive oscillation.

FIG. 24 is a time chart diagram showing a force balanced state of the spool when the current controller of FIG. 22 executes a current control process.

FIG. 25 is a flowchart illustrating a process executed by the current controller of FIG. 22.

FIG. 26 is a block diagram illustrating functional units of the current controller.

FIG. 27 is a time chart diagram showing current and target current when the current controller of FIG. 26 detects excessive oscillation.

FIG. 28 is a flowchart illustrating a process executed by the current controller of FIG. 26.

FIG. 29 is a time chart diagram for explaining the mechanism behind the occurrence of self-induced oscillation of a spool with respect to a comparative example.

### DETAILED DESCRIPTION

Hereinafter, multiple embodiments will be described with reference to the drawings. In the embodiments, components which are substantially similar to each other are denoted by the same reference numerals and redundant description thereof is omitted.

### First Embodiment

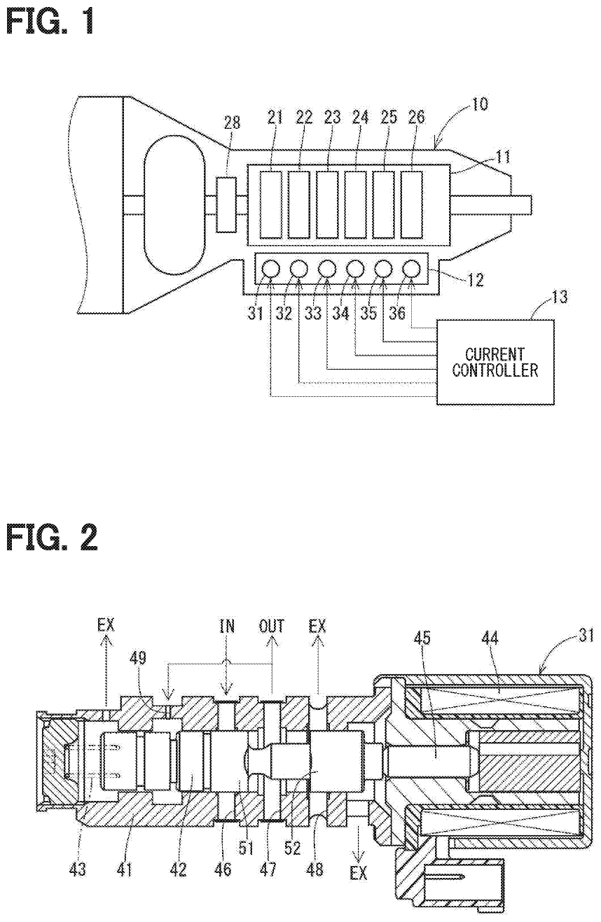

A current controller according to a first embodiment is applied to an automatic transmission shown in FIG. 1. First, an automatic transmission 10 will be described. An automatic transmission 10 includes a transmission mechanism 11, a hydraulic circuit 12, and a current controller 13. The transmission mechanism 11 has multiple friction elements 21 to 26 including, for example, a clutch, a brake, and the like, and a transmission ratio of the transmission mechanism 11 is variable stepwise by selectively engaging the friction elements 21 to 26. The hydraulic circuit 12 has a plurality of linear solenoid valves 31 to 36 for adjusting the pressure of a hydraulic oil pumped from an oil pump 28. The hydraulic oil is supplied to the friction elements 21 to 26.

As shown in FIG. 2, the solenoid valve 31 includes a sleeve 41, a spool 42 that functions as a valve body, a spring 43 that biases the spool 42 in one axial direction, a solenoid 44 configured to produce an electromagnetic force that attracts the spool 42 in the other axial direction, and a plunger 45 provided inside the solenoid 44.

The sleeve 41 has an input port 46, an output port 47, a drain port 48, and a feedback port 49. A part of the hydraulic oil output from the output port 47 flows into the feedback port 49. The hydraulic oil flowing into the feedback port 49 produces a feedback force according to the magnitude of the output hydraulic pressure.

The plunger 45 moves in the axial direction according to the magnitude of the excitation current of the solenoid 44. The spool 42 is movable in the axial direction together with the plunger 45 to change the degree of communication between the input port 46 and the output port 47 and the degree of communication between the output port 47 and the drain port 48. The spool 42 further includes an IN land 51 and an EX land 52. The IN land 51 opens and closes the input port 46. The EX land 52 opens and closes the drain port 48.

The stroke of the spool 42 (also referred to as stroke position) is determined based on a balance between the electromagnetic force of the solenoid 44, the biasing force of the spring 43, and a feedback force corresponding to the output hydraulic pressure of the working oil flowing into the feedback port 49. In this regard, the solenoid valve 31 includes a self-regulating pressure mechanism due to the feedback force.

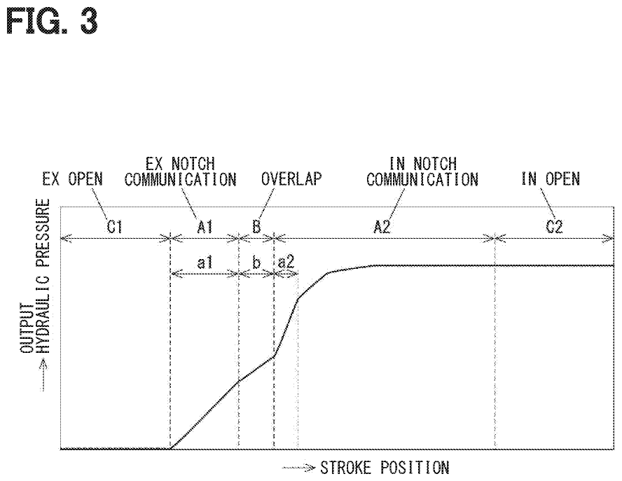

As shown in FIG. 3, the output hydraulic pressure changes according to the stroke of the spool 42. As shown in this relationship, the solenoid valve 31 has a characteristic including hydraulic pressure steep curve regions a1 and a2 as well as a hydraulic pressure gentle curve region b. The rate of change in the output hydraulic pressure with respect to the rate of change in stroke is relatively high in the steep curve regions a1, a2, and is relatively low in the gentle curve region b.

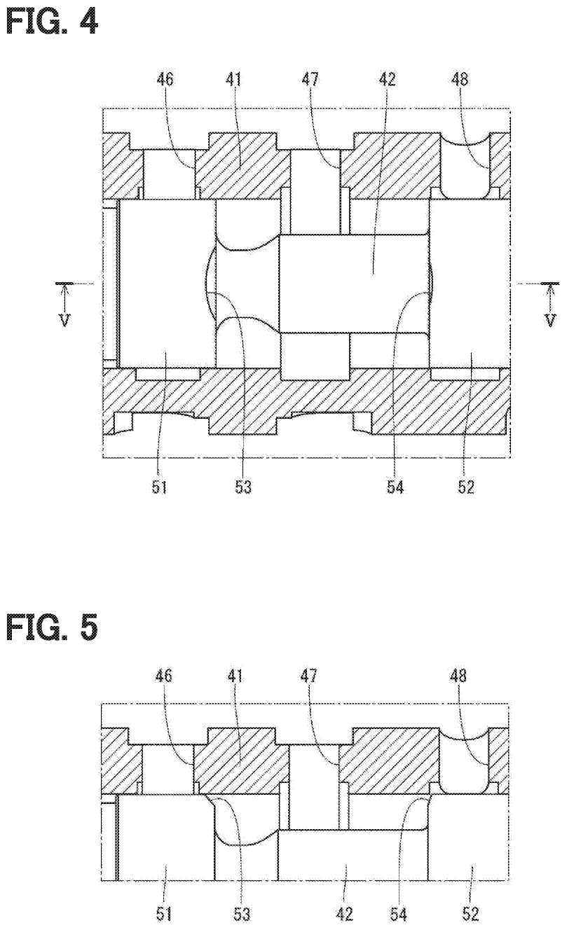

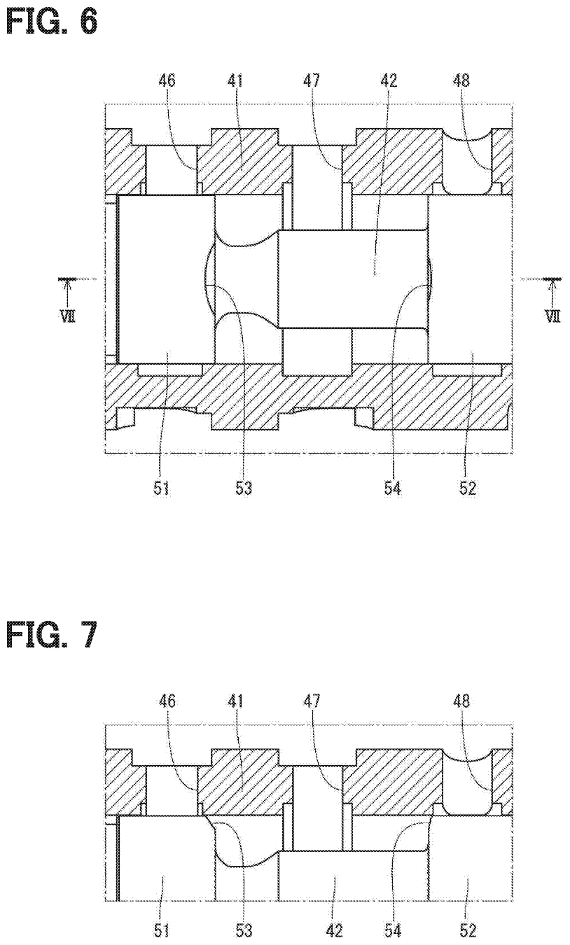

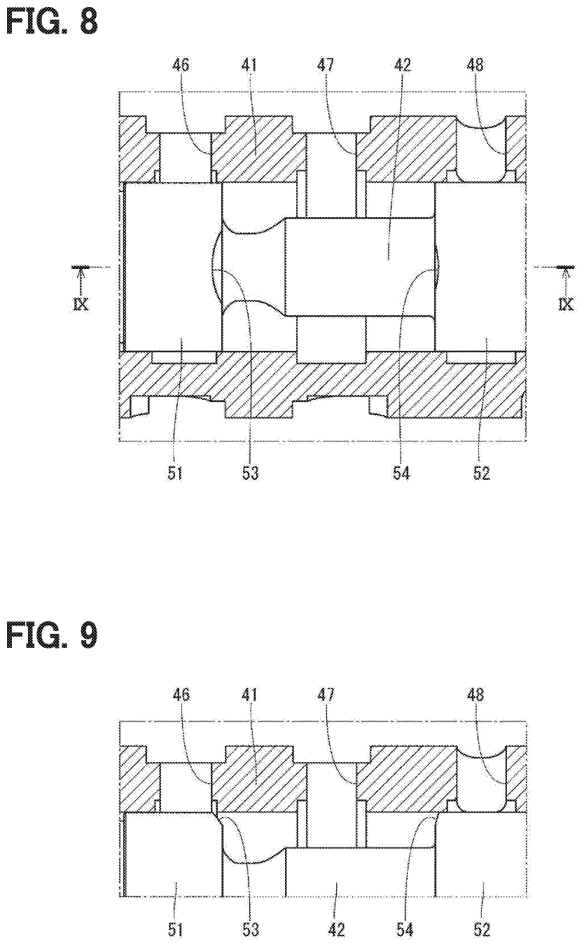

As shown in FIGS. 4 and 5, the hydraulic pressure steep curve region a1 in FIG. 3 is the entire stroke range corresponding to the state in which the drain port 48 is in communication with the output port 47 via only an EX notch 54 of the EX land 52 (also referred to as an EX notch communication range A1). As shown in FIGS. 6 and 7, the hydraulic pressure gentle curve region b in FIG. 3 is the entire stroke range corresponding to the state in which the closure of the input port 46 by the IN land 51 overlaps with the closure of the drain port 48 by the EX land 52 (also referred to as an overlap range B). As shown in FIGS. 8 and 9, the hydraulic pressure steep curve region a2 in FIG. 3 is a portion of the stroke range corresponding to the state in which the input port 46 is in communication with the output port 47 via only an IN notch 53 of the IN land 51 (also referred to as an IN notch communication range A2). Specifically, the hydraulic pressure steep curve region a2 corresponds to a portion of the IN notch communication range A2 which is directly adjacent to the overlap range B.

An EX opening range C1 of FIG. 3 is a stroke range corresponding to the state in which the drain port 48 is in communication with the output port 47 through the space between the EX land 52 and the IN land 51 rather than being in communication via only with the EX land 52. In addition, an IN opening range C2 of FIG. 3 is a stroke range corresponding to the state in which the input port 46 is in communication with the output port 47 through the space between the EX land 52 and the IN land 51 rather than being in communication via only with the IN land 51.

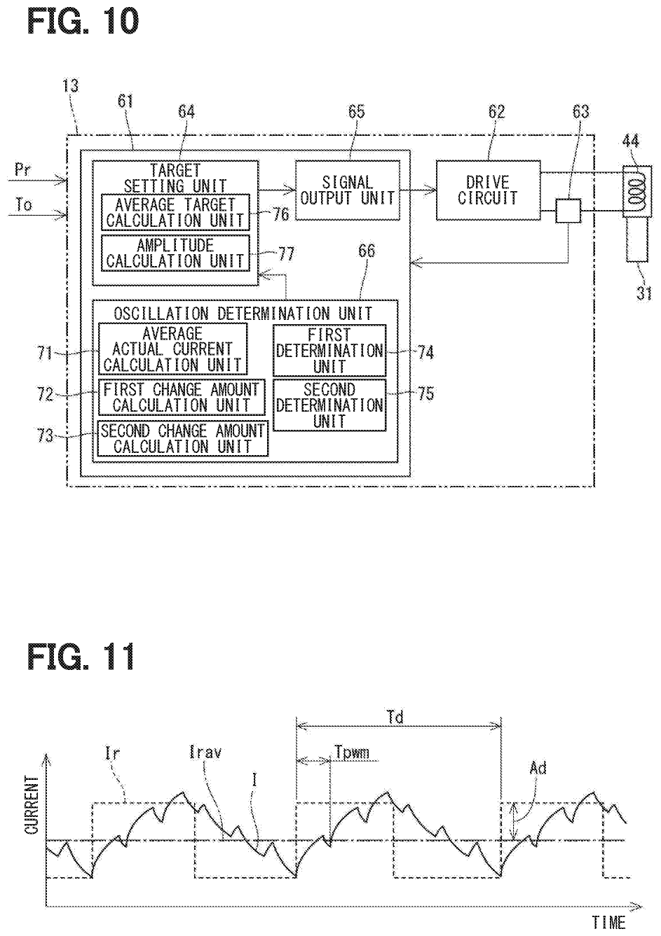

As shown in FIG. 10, the current controller 13 includes a microcontroller 61, a drive circuit 62 that functions as a drive unit, and a current detector 63 that detects the current actually flowing in the solenoid 44 (hereinafter, referred to as “actual current”). The microcontroller 61 is programmed to execute control processes based on the output values of the current detector 63 and other devices and sensors, which are not illustrated. The microcontroller 61 may be referred to as a processor. The microcontroller 61 includes a target setting unit 64 that sets a target current of the solenoid 44 according to a target output hydraulic pressure for the solenoid valves 31 to 36, and a signal output unit 65 that generates and outputs a drive signal based on the target current. The signal output unit 65 sets the duty ratio of the drive signal such that the actual current of the solenoid 44 follows the target current, i.e., by generating and outputting the drive signal so as to reduce the difference between the actual current and the target current. The drive circuit 62 energizes the solenoid 44 with a predetermined energization period according to the drive signal. In this way, the current controller 13 controls the current of the solenoid 44. The current detector 63 may be a current sensor that directly measures the actual current of the solenoid 44 or a different type of sensor that measures a value correlated with the actual current of the solenoid 44.

### Current Control

Next, the current control by the current controller 13 will be described. The current controller 13 controls the current of the solenoid 44 with a pulse width modulation signal (PWM signal). As shown in FIG. 11, the operation of energizing and then de-energizing the solenoid 44 is repeated with a PWM period Tpwm, and the average value of the current I in the solenoid 44 is maintained near the average target current Irav. At this time, a dither amplitude Ad is added to the target current Ir so that the current I periodically changes with a dither period Td longer which is longer than the PWM period Tpwm. As a result, the spool 42 vibrates slightly and the spool 42 is maintained in a dynamic friction state.

When the current of the solenoid 44 is periodically changed with the dither period Td as described above, the occurrence of hysteresis due to the static friction of the spool 42 is reduced. On the other hand, the balance of the force on the spool 42 may be lost and the pulsation of the output hydraulic pressure may increase, which may lead to self-induced oscillation of the spool 42. The mechanism of occurrence of this phenomenon is as follows.

There are the following three prerequisites for the occurrence of self-induced oscillation.

<Precondition 1> The solenoid valve 31 has a self-regulating function due to a feedback force according to the output hydraulic pressure.
<Precondition 2> In order to ensure the linearity of the relationship between current and output hydraulic pressure, the solenoid valve 31 characteristic includes both a hydraulic pressure steep curve region and a hydraulic pressure gentle curve region. In the steep region, the degree of change in the output hydraulic pressure of the solenoid valve 31 with respect to the change in stroke is relatively steep. In contrast, in the gentle region, the degree of change in the output hydraulic pressure of the solenoid valve 31 with respect to the change in stroke is relatively gentle.
<Precondition 3> The dither amplitude Ad is applied to the target current Ir of the solenoid 44 such that the target current Ir of the solenoid 44 cyclically changes with the dither period Td which is longer than the energization period of the solenoid 44.

When the current control is performed under these prerequisite conditions, the pulse width of the output hydraulic pressure varies depending on the stroke of the spool 42 even if the same dither amplitude is applied to the target current. As a result, at time t101 in FIG. 29, the pulsation of the output hydraulic pressure changes when the stroke of the spool 42 transitions from the hydraulic pressure steep curve region al into the hydraulic pressure gentle curve region b. When the self-regulating pressure function occurs in response to this and the stroke return amount increases, the balance of the forces acting on the spool 42 is lost. From this state, at time t102 in FIG. 29, when the stroke position crosses the hydraulic pressure gentle curve region b and enters the hydraulic pressure steep curve region a2, the pulsation of the output hydraulic pressure changes again. When this is repeated, the rise of the output hydraulic pressure starts to be delayed, the balance of the forces is further disturbed, and the pulsation of the output hydraulic pressure increases. As a result, when the oscillation frequency of the spool 42 reaches the vicinity of resonance frequency around time t103 in FIG. 29, self-induced oscillation occurs and the spool 42 oscillates.

When excessive oscillation such as self-excited oscillation or coupled oscillation occurs in the solenoid valve 31, the output hydraulic pressure oscillates greatly and controllability deteriorates. Therefore, it is important to detect the occurrence of excessive oscillation and take countermeasures. Conventionally, this determination has been made based on the detection value from a hydraulic pressure sensor. However, the provision of the hydraulic pressure sensor is not preferable because it causes an increase in the size, weight, and cost of the hydraulic circuit.

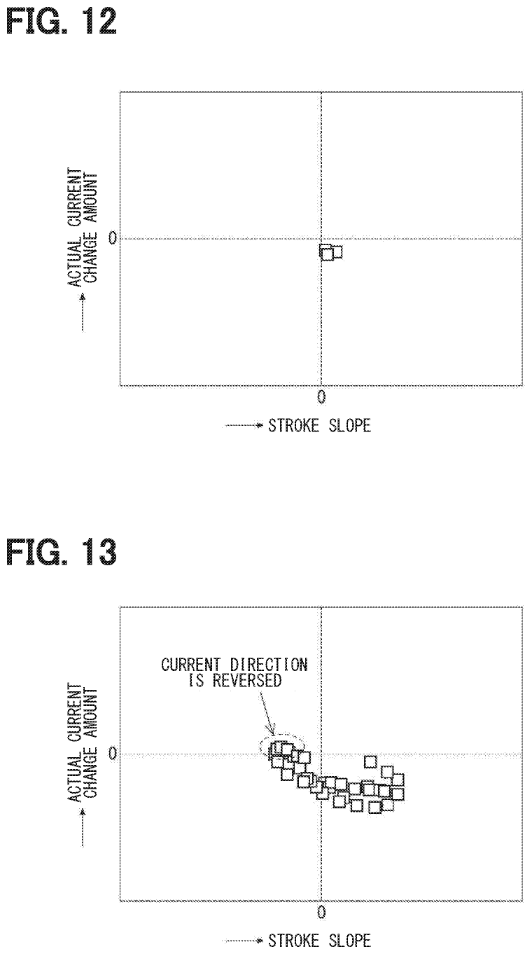

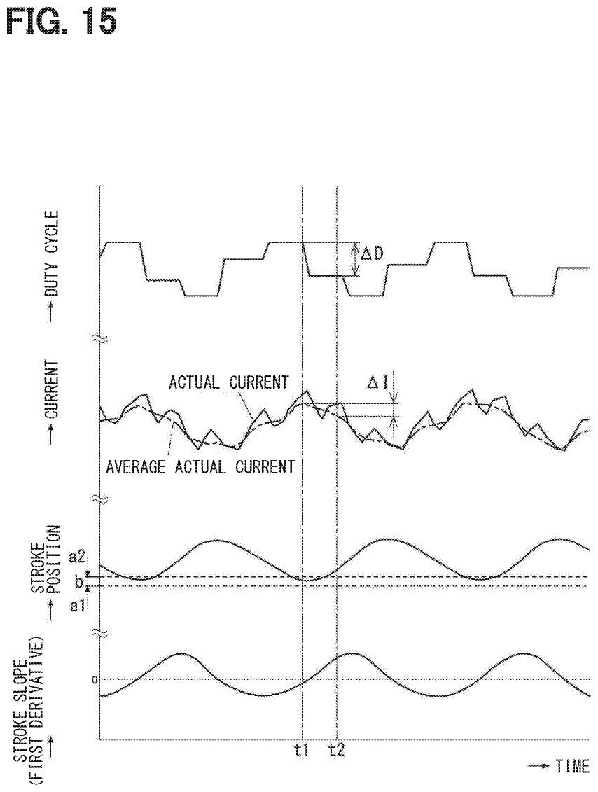

Therefore, when research was conducted to detect excessive oscillation without using a hydraulic pressure sensor, the following was found. FIGS. 12 to 14 show the relationship between stroke slope and actual current change amount ΔI when the duty ratio change amount ΔD is within a predetermined range (−d±e%), in each of: a stable period, an excessive oscillation transition period, and an excessive oscillation occurrence period. The duty ratio change amount ΔD is a change amount of the duty ratio D in a predetermined time period. For example, in FIG. 15, time t1 and time t2 are separated from each other by the predetermined time period. Here, the change in the duty ratio D from time t1 to time t2 is the duty ratio change amount ΔD. The actual current change amount ΔI is a change amount of the actual current over the predetermined time period. For example, in FIG. 15, since time t2 and time t2 are separated from each other by the predetermined time period, the amount of change in the average actual current between time t1 and t2 is the actual current change amount ΔI. The predetermined time period is set to be shorter than the PWM period Tpwm, for example. The average actual current is, for example, an average value of the actual current over a period shorter than the PWM period Tpwm.

In the stable period shown in FIG. 12, the positional relationship between the stroke slope and the actual current change amount ΔI with respect to the duty ratio D is concentrated substantially in one area, i.e., variations are small. Here, stroke slope refers to change in the stroke position of the spool 42 with respect to time, i.e., how fast and in which direction the stroke position of the spool 42 is changing. On the other hand, in the excessive oscillation transition period shown in FIG. 13, the actual current change amount ΔI differs depending on the stroke slope with respect to the duty ratio D. When the stroke slope is positive, the actual current change amount ΔI is relatively small. When the stroke slope is negative, the actual current change amount ΔI is relatively large. However, there is a region in which the direction of the actual current change amount ΔI with respect to the duty ratio D is reversed.

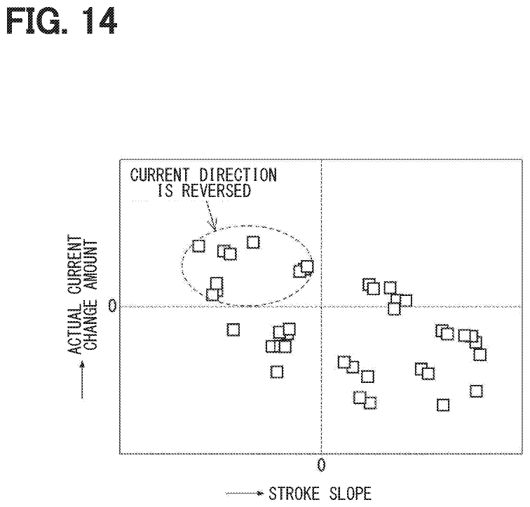

In the excessive oscillation occurrence period shown in FIG. 14, the positional relationship between the stroke slope and the actual current change amount ΔI with respect to the duty ratio D shows the same tendency as in the excessive oscillation transition period. However, since the stroke slope is large due to excessive oscillation, the actual current change amount ΔI is also large.

As described above, in the excessive oscillation occurrence period and the excessive oscillation transition period, the actual current of the solenoid 44 behaves differently from the stable period. This is because when the pulsation of the output hydraulic pressure becomes large due to oscillations, the phase of the stroke change of the valve body is delayed as compared to when the pulsation of the output hydraulic pressure is small, and the inductance of the solenoid is different. Therefore, it is considered that even when the duty ratio of the drive signal is set in the same manner as when the pulsation of the output hydraulic pressure is small, the current actually flowing in the solenoid differs.

The current controller 13 includes an oscillation determination unit 66 for determining whether or not excessive oscillation such as self-induced oscillation or coupled oscillation is occurring or is likely to occur (i.e., trending toward excessive oscillation), and a target setting unit 64 for reducing the occurrence of excessive oscillations.

### Functional Units of Current Controller

Next, the oscillation determination unit 66 and the target setting unit 64 will be described with reference to FIG. 10. The target setting unit 64 applies a dither amplitude Ad to the target current Ir so that the target current Ir changes periodically with a dither period Td longer than the energization period (that is, the PWM period Tpwm). The oscillation determination unit 66 determines, based on the behavior of the actual current, whether excessive oscillation is occurring or is trending toward excessive oscillation as compared to the minor oscillations caused by applying the dither amplitude Ad to the target current Ir. The target setting unit 64 sets the dither amplitude Ad of the target current Ir according to the determination result of the oscillation determination unit 66.

Specifically, the oscillation determination unit 66 includes an average actual current calculation unit 71, a first change amount calculation unit 72, a second change amount calculation unit 73, a first determination unit 74, and a second determination unit 75. The average actual current calculation unit 71 calculates the average actual current lav which is the average value of the actual current during a certain period.

The first change amount calculation unit 72 calculates the actual current change amount ΔI. The actual current change amount ΔI is a change amount of the average actual current lav, starting from when the duty ratio D is changed and until a predetermined time period elapses. For example, if lav1 denotes the average actual current lav before the duty ratio is changed, and lav2 denotes the average actual current lav upon the predetermined time period elapsing after the duty ratio is changed, then the actual current change amount ΔI is lav1-lav2.

The second change amount calculation unit 73 calculates the duty ratio change amount ΔD. The duty ratio change amount ΔD is the change amount of the duty ratio D starting from when the duty ratio D is changed and until the predetermined time period elapses. That is, the duty ratio change amount ΔD is the difference between a duty ratio D1 before the change and a duty ratio D2 after the change.

The first determination unit 74 allows the execution of the second determination unit 75 when the absolute value of the actual current change amount ΔI is equal to or greater than a predetermined first threshold value Th1 and the absolute value of the duty ratio change amount ΔD is equal to or greater than a predetermined second threshold value Th2. That is, the first determination unit 74 allows the execution of the second determination unit 75 when both |ΔI|≥Th1 (i.e., ΔI≥Th1 or −Th1≥ΔI) and |ΔD|≥Th2 (i.e., ΔD≥Th2 or −Th2≥ΔAD) are satisfied. The first threshold value Th1 is a value that is set in advance to exclude values that may lead to an erroneous judgment in determining the direction of the change in the actual current change amount ΔI (e.g., values close to zero). It may be set to, for example, half or two thirds of the maximum design value of ΔI. However, the first threshold value Th1 is not limited to these examples, and may be set to another value. The second threshold Th2 is a value that is set in advance to exclude values that may lead to an erroneous judgment in determining the direction of the change in the duty ratio change amount ΔD (e.g., values close to zero). It is set to, for example, half or two-thirds of the maximum design value of ΔD. However, the second threshold value Th2 is not limited to these examples, and may be set to another value.

The second determination unit 75 determines that excessive oscillation is occurring or is trending toward excessive oscillation when the direction of change of the actual current change amount ΔI is different from the direction of change of the duty ratio change amount ΔD. For example, when the product of the actual current change amount ΔI and the duty ratio change amount ΔD is smaller than zero, it is determined that the two change directions are different from each other.

The target setting unit 64 includes an average target calculation unit 76 and an amplitude calculation unit 77. The average target calculation unit 76 calculates the average target current lrav based on the target output hydraulic pressure Pr. For example, the target output hydraulic pressure Pr may be a value input from an external source. However, this is not limiting, and the target output hydraulic pressure Pr may be calculated by the current controller 13.

When the determination by the second determination unit 75 is negative (that is, when excessive oscillation is not occurring and is not trending toward excessive oscillation), the amplitude calculation unit 77 calculates a first dither amplitude Ad1 based on at least the average target current Irav, and this first dither amplitude Ad1 is used as the dither amplitude Ad. In the first embodiment, the amplitude calculation unit 77 calculates the first dither amplitude Ad1 based on the average target current Irav and the oil temperature To. Further, when the determination by the second determination unit 75 is affirmative (that is, when excessive oscillation occurring or is trending toward excessive oscillation), the amplitude calculation unit 77 sets a second dither amplitude Ad2 as the dither amplitude Ad. The second dither amplitude Ad2 is lower than the first dither amplitude Ad1.

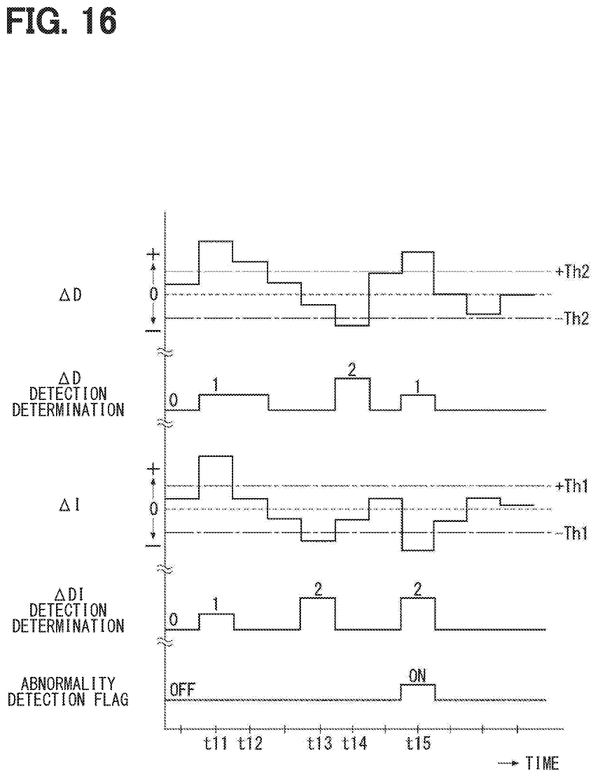

As described above, the oscillation determination unit 66 determines, based on the behavior of the actual current, whether excessive oscillation is occurring or is trending toward excessive oscillation in the solenoid valve 31. As shown in FIG. 16, the ΔD detection flag is set to 1 at times t11 and t15 when ΔD≥Th2. The ΔD detection flag is set to 2 at time t14 when −Th2≥ΔD. The ΔI detection flag is set to 1 at time t11 when ΔI≥Th1. The ΔI detection flag is set to 2 at times t13 and t15 when −Th1≥ΔI. In this case, the second determination unit 75 is executed at times t11 and t15 when the ΔD detection flag is 1 or 2 and the ΔI detection flag is 1 or 2. Then, at t15 when the numerical values of the both flags are different, the abnormality detection flag is turned on, and it is determined that excessive oscillation is occurring or is trending toward excessive oscillation.

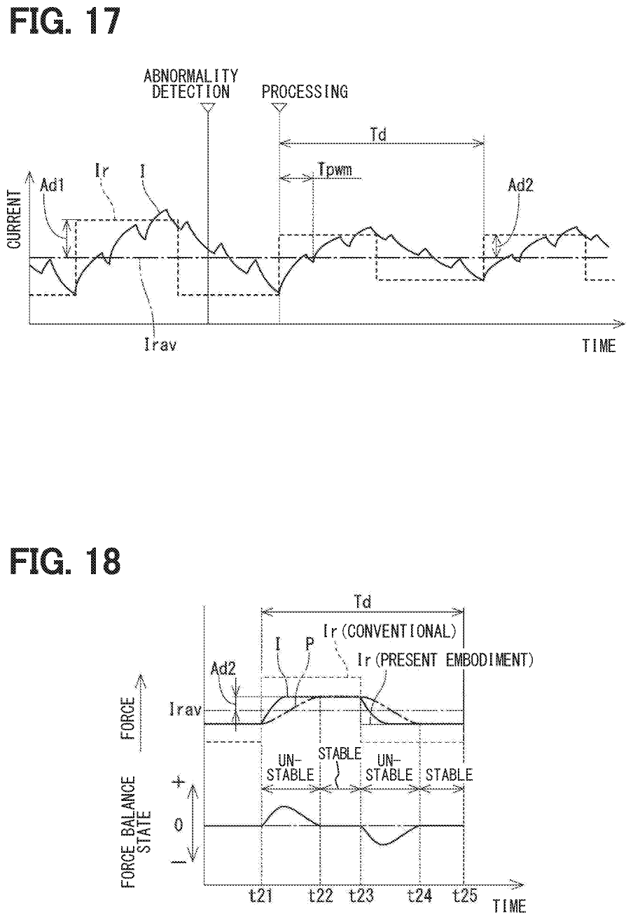

When an abnormality is detected in this way, the dither amplitude Ad is set to be the second dither amplitude Ad2 which is relatively low so that the stroke of the spool 42 does not cross through the hydraulic pressure gently curve region b, as shown in FIG. 17. By decreasing the second dither amplitude Ad2 in this way, even if the balance of forces is slightly disturbed and the balance state becomes unstable as shown at time t21 to t22 and time t23 to t24 in FIG. 18, the balance of forces returns immediately so the amount of time spent in the unable state is short. In this example, stable states are provided at time t22 to t23 and time t24 to t25 in FIG. 18.

Each of the functional units 64 to 66 and 71 to 78 included in the current controller 13 may be realized by hardware processing performed by a dedicated logic circuit, may be realized by software processing by executing a program stored in advance in a memory such as a computer-readable non-transitory tangible recording medium or the like by a CPU, or may be realized by a combination of the hardware processing and the software processing. Which part of the functional units 64 to 66 and 71 to 78 is realized by hardware processing and which part is realized by software processing can be appropriately selected.

### Current Controller Processing

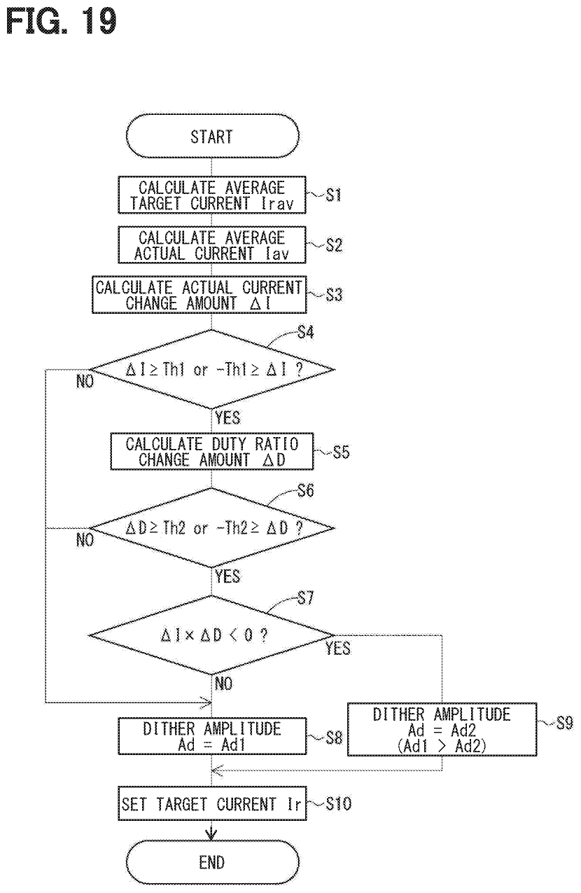

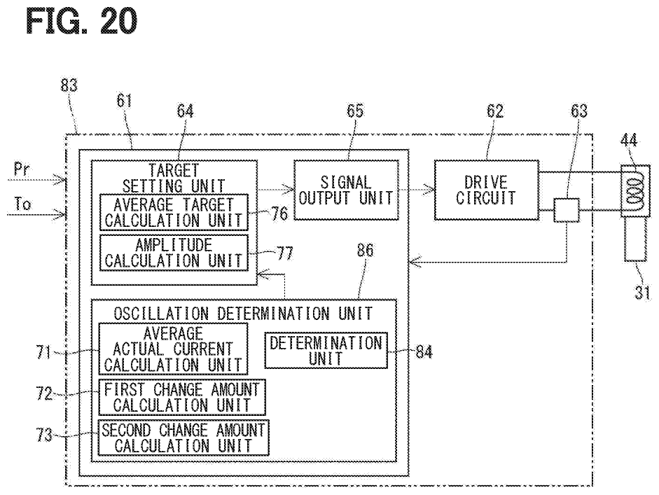

Next, the processing executed by the current controller 13 for determining the presence or absence of excessive oscillation and for setting the target current will be described with reference to FIG. 19. The processing routine shown in FIG. 19 is repeatedly executed each time a predetermined time period elapses after the duty ratio is changed. Hereinafter, “S” means step.

In S1 of FIG. 19, the average target current Irav is calculated. After S1, the processing proceeds to S2.

In S2, the average actual current lav is calculated. After S2, the processing proceeds to S3.

In S3, the actual current change amount ΔI is calculated as the change amount of the average actual current lav from when the duty ratio is changed and until the elapse of a predetermined time period. In other words, the actual current change amount ΔI is the difference between a previous average actual current lav1 and a current average actual current lav2. After S3, the processing proceeds to S4.

In S4, it is determined whether or not the absolute value of the actual current change amount ΔI is greater than or equal to a predetermined first threshold Th1. In other words, it is determined whether or not either ΔI≥Th1 or −Th1≥ΔI is satisfied. If either ΔI≥Th1 or −Th1≥ΔI is satisfied (S4: YES), the processing proceeds to S5. If both ΔI≥Th1 and −Th1≥ΔI are not satisfied (S4: NO), the processing proceeds to S8.

In S5, the duty ratio change amount ΔD is calculated as the difference between the duty ratio prior to being changed and the duty ratio after being changed. In other words, the duty ratio change amount ΔD is the difference between the duty ratio D1 at the time of the previous processing routine and the duty ratio D2 during the current processing routine. After S5, the processing proceeds to S6.

In S6, it is determined whether or not the absolute value of the duty ratio change amount ΔD is greater than or equal to a predetermined second threshold Th2. That is, it is determined whether or not one of ΔD≥Th2 or −Th2≥ΔD is satisfied. If either ΔD≥Th2 or −Th2≥ΔD is satisfied (S6: YES), the processing proceeds to S7. If both ΔD≥Th2 and −Th2≥ΔD are not satisfied (S6: NO), the processing proceeds to S8.

In S7, it is determined whether or not the changing direction of the actual current change amount ΔI is different from the changing direction of the duty ratio change amount ΔD. That is, it is determined whether or not ΔI×ΔD<0 is satisfied. If ΔI×ΔD<0 is satisfied (S7: YES), the processing proceeds to S9. If ΔI×ΔD<0 is not satisfied (S7: NO), the processing proceeds to S8.

In S8, the first dither amplitude Ad1 is calculated based on the average target current Irav and the oil temperature To, and the first dither amplitude Ad1 is set as the dither amplitude Ad. After S8, the processing proceeds to S10.

In S9, the second dither amplitude Ad2 is calculated and is set as the dither amplitude Ad. The second dither amplitude Ad2 is smaller than the first dither amplitude Ad1. After S9, the processing proceeds to S10.

In S10, the target current Ir is set based on the average target current Irav, the dither amplitude Ad, and the dither period Td. The dither period Td is a predetermined value. After S10, the processing exits the routine of FIG. 19.

### Effects

As described above, in the first embodiment, the current controller 13 is applied to the solenoid valves 31 to 36 which have a self-regulating pressure function due to the feedback force from the output hydraulic pressure.

The current controller 13 includes the current detector 63 that detects the actual current across the solenoid 44, the drive circuit 62 that energizes the solenoid 44 with a PWM period Tpwm according to a drive signal, the signal output unit 65 that generates and outputs the drive signal by setting the duty ratio D of the drive signal such that the actual current approaches the target current Ir, and the target setting unit 64 that applies a dither amplitude Ad to vary the target current Ir periodically with a dither period Td that is longer than the PWM period Tpwm. The current controller 13 further includes the oscillation determination unit 66 that determines, based on the behavior of the actual current, whether excessive oscillation is occurring or is trending toward excessive oscillation as compared to the minor oscillations caused by applying the dither amplitude Ad to the target current Ir.

By determining based on the behavior of the actual current in this manner, it is possible to detect the occurrence of excessive oscillation of the solenoid valves 31 to 36 without requiring a hydraulic pressure sensor.

Further, in the first embodiment, the oscillation determination unit 66 determines that based on the behavior of the actual current excessive oscillation is occurring or is trending toward excessive oscillation when the absolute value of a change amount of the actual current Al over a predetermined period of time is equal to or greater than the predetermined first threshold value Th1 and the absolute value of a change amount of the duty ratio ΔD over the predetermined period of time is equal to or greater than a predetermined second threshold value Th2. Due to this, erroneous detection can be prevented.

Further, in the first embodiment, the oscillation determination unit 66 determines that excessive oscillation is occurring or is trending toward excessive oscillation when the direction of change of the actual current over the predetermined time period is different from the direction of change of the duty ratio over the predetermined time period. In this way, the occurrence of excessive oscillation in the solenoid valves 31 to 36 can be detected.

In addition, in the first embodiment, the target setting unit 64 reduces the dither amplitude Ad when it is determined that excessive oscillation is occurring or is trending toward excessive oscillation as compared to when this determination is negative. By reducing the dither amplitude Ad in this manner, the balance of the forces on the spool 42 is maintained. Therefore, the oscillations of the solenoid valves 31 to 36 can be reduced.

### Second Embodiment

In the second embodiment, as shown in FIG. 20, an oscillation determination unit 86 of a current controller 83 includes an average actual current calculation unit 71, a first change amount calculation unit 72, a second change amount calculation unit 73, and a determination unit 84. The determination unit 84 determines that excessive oscillation is occurring or is trending toward excessive oscillation when the change amount ΔI of the actual current over a predetermined time period is not within a design value range (ΔId±α) determined according to the change amount ΔD of the duty ratio D over the predetermined time period. The design value range is centered on a design value ΔId for the actual current change amount with a width ranging between plus and minus a predetermined value α. The design value range (ΔId±α) may, for example, be set such that the sign of the actual current change amount Al does not reverse.

### Current Controller Processing

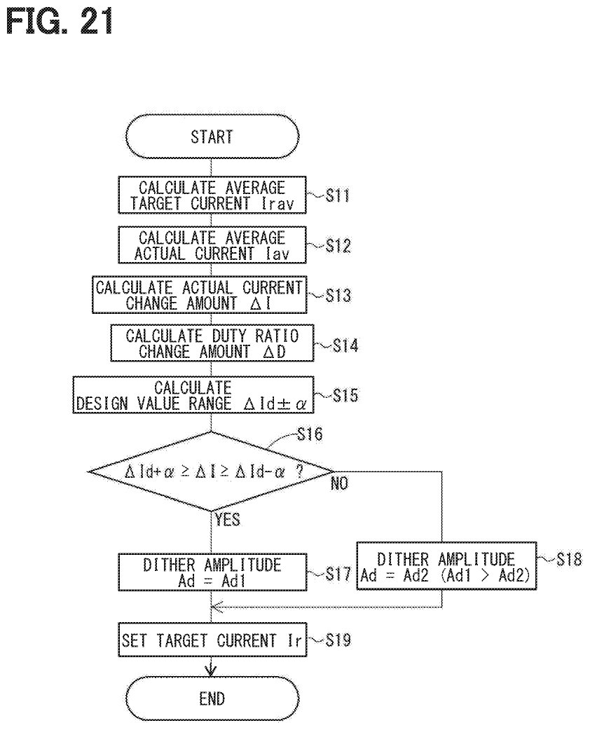

Next, the processing executed by the current controller 83 for determining the presence or absence of excessive oscillation and for setting the target current will be described with reference to FIG. 21. The processing routine shown in FIG. 21 is repeatedly executed each time a predetermined time period elapses after the duty ratio is changed.

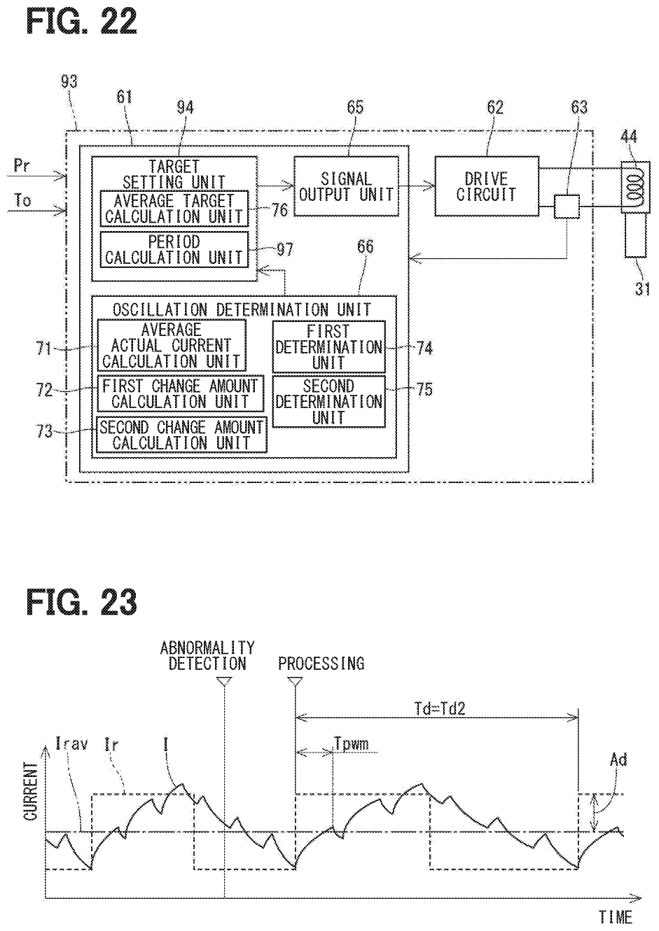

In S11 to S14 and S17 to S19 of FIG. 22, the same processing as 51 to S4 and S8 to S10 of FIG. 19 of the first embodiment are performed.

In S15, the design value range (ΔId±α) of the actual current change amount is calculated based on the duty ratio change amount ΔD. After S15, the processing proceeds to S16.

In S16, it is determined whether or not the actual current change amount ΔI is within the design value range (ΔId±α). If the actual current change amount ΔI is within the design value range (ΔId±α) (S16: YES), the processing proceeds to S17. If the actual current change amount ΔI is not within the design value range (ΔId±α) (S16: NO), the processing proceeds to S18.

### Effects

As described above, in the second embodiment, the current controller 83 includes the oscillation determination unit 86 that determines whether or not excessive oscillation is occurring or is trending toward excessive oscillation based on the behavior of the actual current. Therefore, similar to the first embodiment, it is possible to detect the occurrence of excessive oscillation of the solenoid valves 31 to 36 without requiring a hydraulic pressure sensor.

In addition, in the second embodiment, the determination unit 84 of the oscillation determination unit 86 determines that excessive oscillation is occurring or is trending toward excessive oscillation when the actual current change amount ΔI is not within a design value range (ΔId±α) determined according to the duty ratio change amount ΔD. In this way, the occurrence of excessive oscillation in the solenoid valves 31 to 36 can be detected.

### Third Embodiment

In the third embodiment, as shown in FIG. 22, a target setting unit 94 of a current controller 93 includes an average target calculation unit 76 and a period calculation unit 97. When the determination by the second determination unit 75 is negative (that is, when excessive oscillation is not occurring and is not trending toward excessive oscillation), the period calculation unit 97 sets the dither period Td to be a predetermined first period Td1. Further, when the determination by the second determination unit 75 is affirmative (that is, when excessive oscillation is occurring or is trending toward excessive oscillation), the period calculation unit 97 sets the dither period Td to be a predetermined second period Td2 that is longer than the first period Td1. The first period Td1 and the second period Td2 are set to values at which the dynamic friction state of the spool 42 is maintained, in order to prevent hysteresis caused by static friction of the spool 42.

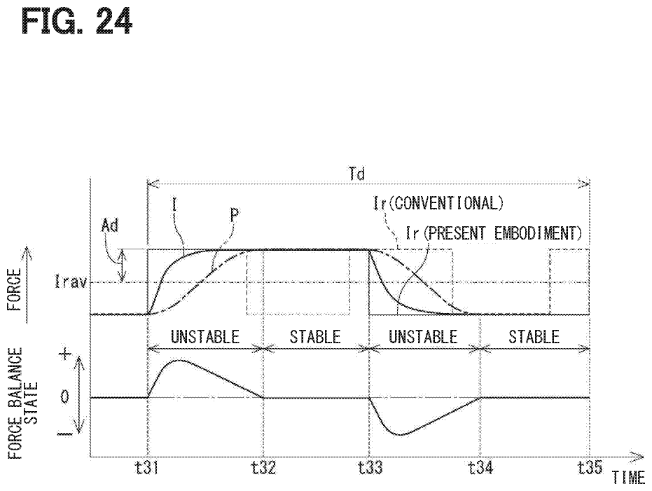

When excessive oscillation is occurring or is trending toward excessive oscillation as described above, the dither period is set to be the relatively long second dither period Td2 as shown in FIG. 23. By increasing the dither period Td in this way, even if the balance of forces is slightly disturbed and the balance state becomes unstable as shown at time t31 to t32 and time t33 to t34 in FIG. 24, it is possible to provide stable time periods to bring balance to the force. In this example, stable states are provided at time t32 to t33 and time t34 to t35 in FIG. 24.

### Current Controller Processing

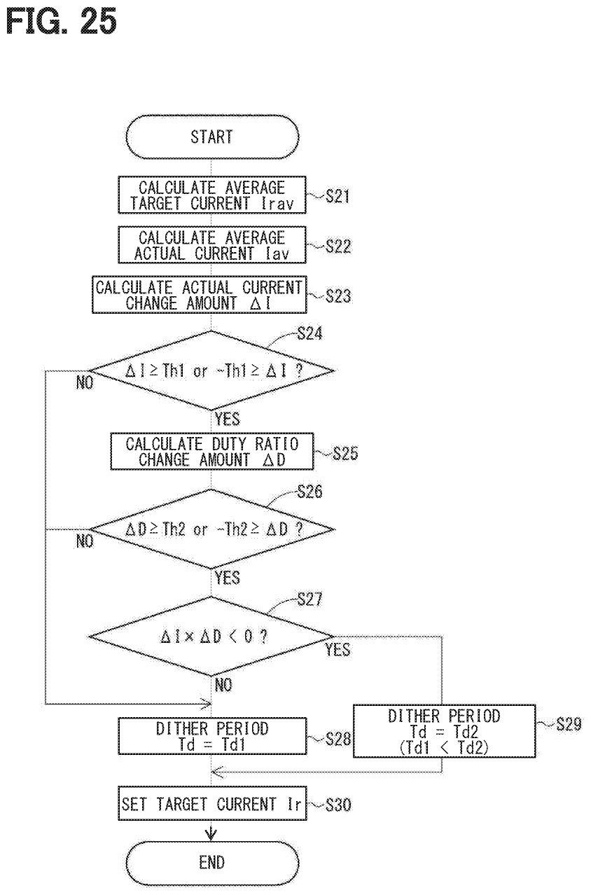

Next, the processing executed by the current controller 83 for determining the presence or absence of excessive oscillation and for setting the target current will be described with reference to FIG. 25. The processing routine shown in FIG. 25 is repeatedly executed each time a predetermined time period elapses after the duty ratio is changed.

In S21 to S27 and S30 of FIG. 25, the same processing as S1 to S7 and S10 of FIG. 19 of the first embodiment are performed.

In S28, the predetermined first period Td1 is set as the dither period Td. After S28, the processing proceeds to S30.

In S29, the predetermined second period Td2, which is longer than the first period Td1, is set as the dither period Td. After S29, the processing proceeds to S30.

### Effects

As described above, in the third embodiment, the current controller 93 includes the oscillation determination unit 66. Therefore, similar to the first embodiment, it is possible to detect the occurrence of excessive oscillation of the solenoid valves 31 to 36 without requiring a hydraulic pressure sensor.

In addition, in the third embodiment, the target setting unit 94 increases the dither period Td when it is determined that excessive oscillation is occurring or is trending toward excessive oscillation as compared to when this determination is negative. By increasing the dither period Td in this way, even if the balance of forces on the spool 42 is slightly disturbed and the balance state becomes unstable, it is possible to provide stable time periods to bring balance to the force. Therefore, the oscillations of the solenoid valves 31 to 36 can be reduced.

### Fourth Embodiment

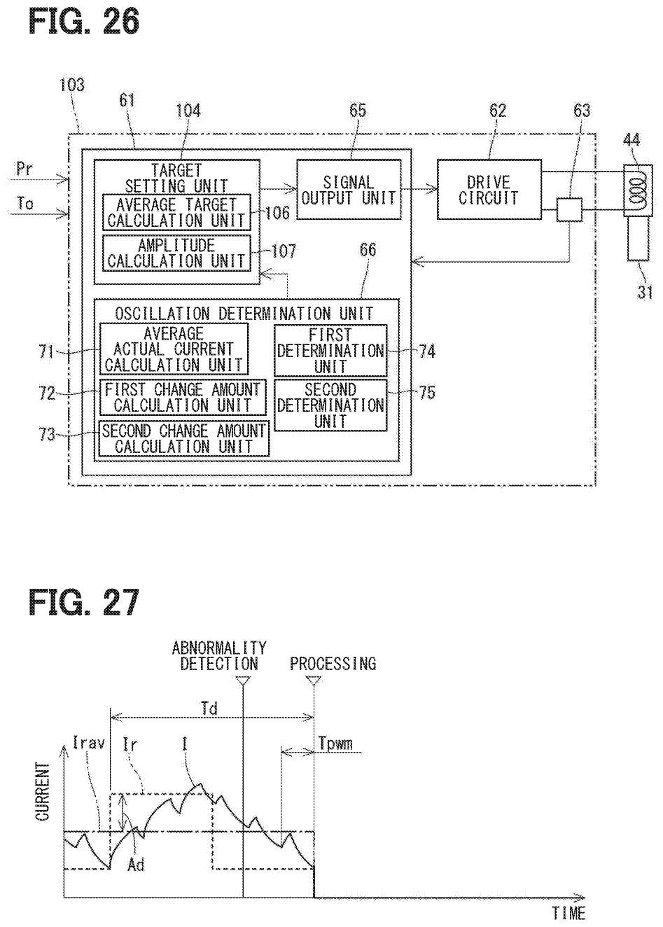

In the fourth embodiment, as shown in FIG. 26, a target setting unit 104 of a current controller 103 includes an average target calculation unit 106 and an amplitude calculation unit 107. The average target calculation unit 106 calculates the average target current Irav based on the target output hydraulic pressure Pr. Further, when the determination by the second determination unit 75 is affirmative (that is, when excessive oscillation is occurring or is trending toward excessive oscillation), the average target calculation unit 106 sets the average target current Irav to be zero. In addition, the amplitude calculation unit 107 sets the dither amplitude Ad to zero when the determination by the second determination unit 75 is affirmative. In other words, the target setting unit 104 sets the target current Ir to zero when the determination by the second determination unit 75 is affirmative. The target current Ir is continued to be applied for a predetermined period of time so as to not hinder pressure regulation.

When excessive oscillation is occurring or is trending toward excessive oscillation, the target current Ir is set to zero as shown in FIG. 27. As a result, the electromagnetic force of the oscillation energy can be cut off, thereby stopping the occurrence of the oscillation.

### Current Controller Processing

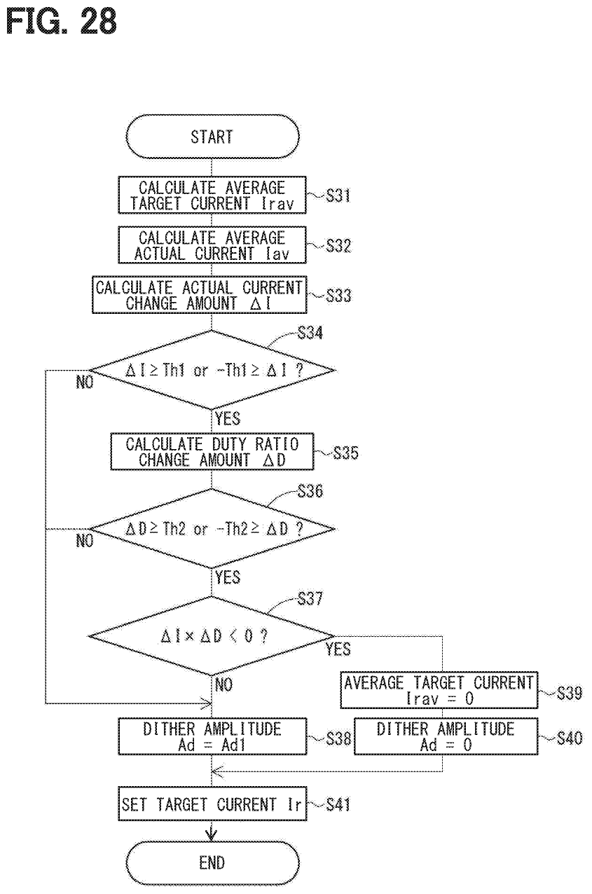

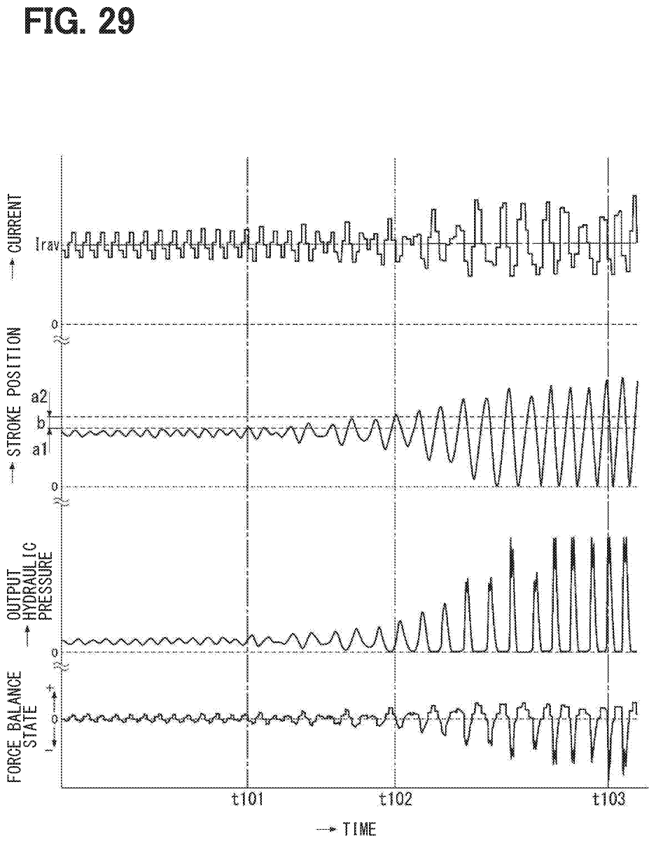

Next, the processing executed by the current controller 103 for determining the presence or absence of excessive oscillation and for setting the target current will be described with reference to FIG. 28. The processing routine shown in FIG. 28 is repeatedly executed each time a predetermined time period elapses after the duty ratio is changed.

In S31 to S38 and S41 of FIG. 28, the same processing as S1 to S7 and S10 of FIG. 19 of the first embodiment are performed.

In S39, the average target current Irav is set to zero. After S39, the processing proceeds to S40.

In S40, the dither amplitude Ad is set to zero. After S40, the processing proceeds to S41.

### Effects

As described above, in the fourth embodiment, the current controller 103 includes the oscillation determination unit 66. Therefore, similar to the first embodiment, it is possible to detect the occurrence of excessive oscillation of the solenoid valves 31 to 36 without requiring a hydraulic pressure sensor.

Further, in the fourth embodiment, the target setting unit 104 sets the target current Ir to zero when it is determined that excessive oscillation is occurring or is trending toward excessive oscillation. By setting the target current Ir to zero in this manner, the electromagnetic force of the oscillation energy can be cut off, thereby stopping the occurrence of the oscillation. Therefore, the oscillations of the solenoid valves 31 to 36 can be reduced.

### Other Embodiments

The solenoid valve and the current controller may be collectively referred to as a hydraulic system.

In another embodiment, the current control of the solenoid is not limited to the PWM control, and may be another dither chopper control. In another embodiment, the self-regulating pressure function from the feedback force of the output hydraulic pressure is implemented by detecting the magnitude of the output hydraulic pressure and applying a force corresponding to the detected value to the spool by using, for example, electromagnetic force.

The control circuit and method described in the present disclosure may be implemented by a special purpose computer which is configured with a memory and a processor programmed to execute one or more particular functions embodied in computer programs of the memory. Alternatively, the control circuit described in the present disclosure and the method thereof may be realized by a dedicated computer configured as a processor with one or more dedicated hardware logic circuits. Alternatively, the control circuit and method described in the present disclosure may be realized by one or more dedicated computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium.

The present disclosure has been described based on the embodiments. However, the present disclosure is not limited to the embodiments and structures. This disclosure also encompasses various modifications and variations within the scope of equivalents. Furthermore, various combination and formation, and other combination and formation including one, more than one or less than one element may be made in the present disclosure.

1. A current controller for controlling a current of a solenoid, the current controller being applied to a solenoid valve with a self-regulating pressure function from a feedback force according to an output hydraulic pressure, the current controller comprising:
a current detector configured to detect an actual current of the solenoid;
a drive unit configured to energize the solenoid with a predetermined energization period according to a drive signal;
a signal output unit that sets a duty ratio of the drive signal such that the actual current follows a target current, the signal output unit being configured to generate and output the drive signal;
a target setting unit that applies a dither amplitude to the target current such that the target current changes periodically with a dither period longer than the energization period; and
an oscillation determination unit that determines, based on a behavior of the actual current, whether excessive oscillation is occurring or is trending toward excessive oscillation as compared to minor oscillations caused by applying the dither amplitude to the target current.

2. The current controller according to claim 1, wherein the oscillation determination unit determines based on the behavior of the actual current that excessive oscillation is occurring or is trending toward excessive oscillation when the absolute value of a change amount of the actual current over a predetermined period of time is equal to or greater than a predetermined first threshold value and the absolute value of a change amount of the duty ratio over the predetermined period of time is equal to or greater than a predetermined second threshold value.

3. The current controller according to claim 2, wherein the oscillation determination unit determines that excessive oscillation is occurring or is trending toward excessive oscillation when the direction of change of the actual current over the predetermined time period is different from the direction of change of the duty ratio over the predetermined time period.

4. The current controller according to claim 1, wherein the oscillation determination unit determines that excessive oscillation is occurring or is trending toward excessive oscillation when a change amount of the actual current over a predetermined time period is outside of a design value range determined according to a change amount of the duty ratio over the predetermined time period.

5. The current controller according to claim 1, wherein the target setting unit reduces the dither amplitude when it is determined that excessive oscillation is occurring or is trending toward excessive oscillation as compared to when this determination is negative.

6. The current controller according to claim 1, wherein the target setting unit increases the dither period when it is determined that excessive oscillation is occurring or is trending toward excessive oscillation as compared to when this determination is negative.

7. The current controller according to claim 1, wherein the target setting unit sets the target current to zero when it is determined that excessive oscillation is occurring or is trending toward excessive oscillation.

8. A hydraulic system, comprising:
a solenoid valve including a plurality of ports and a solenoid, the plurality of ports including a feedback port that generates a feedback force according to an output hydraulic pressure of the solenoid valve;
a current sensor configured to detect an actual current of the solenoid;
a drive circuit configured to energize the solenoid with a predetermined energization period according to a drive signal; and
a processor coupled to the current sensor and the drive circuit, the processor being programmed to:
generate and output the drive signal with a duty ratio such that the actual current follows a target current, the target current having applied thereto a dither amplitude such that the target current changes periodically with a dither period longer than the energization period,
determines whether excessive oscillation is occurring or is likely to occur by comparing a change over time of the actual current with respect to a change over time of the duty ratio, and
upon determining that excessive oscillation is occurring or is likely to occur, adjust the actual current to reduce oscillation.
